(19) United States
(12) Patent Application Publication
(10) Pub. No.: US 2021/0327216 A1
(43) Pub. Date: Oct. 21, 2021

(54) PROCESS & METHOD FOR THE CREATION, MANAGEMENT & DISTRIBUTION OF WAGER-ENABLED GAMES & SKILLS CHALLENGES WITH A GAMING CONTRACTS ENGINE

(71) Applicant: Dollar Dollar Dollar, Inc., Chicago Park, CA (US)

(72) Inventors: Thomas B. Naramore, Grass Valley, CA (US); John Peter Meng, Highlands Ranch, CO (US)

(73) Assignee: Dollar Dollar Dollar, Inc., Chicago Park, CA (US)

(21) Appl. No.: 16/862,557

(22) Filed: Apr. 29, 2020

Related U.S. Application Data
(60) Provisional application No. 62/839,783, filed on Apr. 29, 2019.

(51) Int. Cl. G07F 17/32

(52) U.S. Cl. CPC G07F 17/3258; G07F 17/3288; G07F 17/3255

(57) ABSTRACT

A computerized gaming contract engine (“GCE”) that allows for, among other thing, creation of individually unique games, challenges, and wagers, execution of the games, challenges, and wager, and management of those games. The GCE additionally allows for monitoring execution of the appropriate rules and locations as they pertain to the associated wagers and record actions or other appropriate data to the associated blockchain, “oracle”, or datastore for storing data that is incidental to the execution of the game and need not be recorded to the blockchain. The GCE additionally enables escrow of wager until the game has completed. A GCE may manage rules and wagers during game play, determine data to be distributed to supporting databases or systems, validate compliance of game rules, manage requests for data through an “oracle”, execute rules as required from the data received, determine winners and losers, and then withdraw wagers from an escrow account or directly from the loser(s)'s account(s) and distributes them a digital wallet(s) of the winning player(s).

### CROSS-REFERENCE TO RELATED APPLICATION

This application is related to of U.S. Provisional Application 62/839,783, filed Apr. 29, 2019.

### BACKGROUND

Aspects of the present invention enable a wagering platform, descriptions and examples of which are provided here. Aspects of the present invention advantageously enhance competitiveness and enjoyment by players of both “e-games” or “real world” games through selected side games, skills challenges and/or wagering. Previous attempts at accomplish disparate parts of the present invention fall primarily into two categories: (1) verbal communication plus “hand shake” or (2) single-use digital games.

Regarding the first method (verbal communication plus hand shake), players who participate in real-world games like golf or billiards may verbally issue a skills challenge to one or more competitors before or during a game. Generally, an initiating player will issue the verbal challenge to one or more players, the rules of the challenge, and a wager amount required to participate. After the challenge is complete, the players must “settle-up” amongst themselves and/or personally track or verify the status of various payments of the wager according to the rules of the challenge. This method of wagering is rife with miscommunication, confusion, integrity issues, and accounting issues. For example, players may disagree after the fact regarding the rules, the odds and payout amounts, etc. The method also suffers from a significant disadvantage—it is generally limited to real-time, single location play. Issuing challenges for game play at or across different locations and/or times is difficult at best, or near impossible at worst. For the most part, the wagering challenges can also be issued only to the players at hand, and issuing challenges to more than a few players is difficult to impossible, due to the growing game complexity and communication issues it creates. For virtual games, the challenges are similar although time and location issues may be minimized, but significant issues regarding integrity and wager settlement remain.

Regarding the second method—single-use digital games—there are several digital games or “apps” available that allow players to engage or play “side” games while scoring real-world games like golf or billiards. For example, for golf there are a number of golf-scoring “apps” that allow players to play one of several side games like “Nassau” or “Wolf” against other players in their immediate foursome while they use the app for scoring the round. But these apps suffer from significant disadvantages: 1) they do not use smart contracts or blockchain technologies to record & verify rules, actions, and scoring; 2) they do not include additional skills challenges or wagers; 3) they do not allow one-to-one, one-to-many, or team-to-team remote play of a game against an unlimited number of players at other courses and times; 4) they do not allow the creation of customized or original new games by players, as these games include rules management, verification of play, winner/loser management, wager tracking, holding, and distribution, all of which requires functionality not supported by existing apps; 5) they do not allow players to store smart contract based games in private or public libraries for personal use or sharing; and 6) they do not allow one-to-one, one-to-many, many-to-many, or team-to-team play via customized games unrestricted by location, time, or limited rules.

### BRIEF SUMMARY OF THE INVENTION

The following presents a simplified summary in order to provide a basic understanding of some aspects of the invention. This summary is not an extensive overview. It is not intended to identify key or critical elements of the invention or to delineate the scope of the invention. The following summary merely presents some concepts of the invention in a simplified form as a prelude to the more detailed description provided below.

Aspects of the present invention relate to one or more methods, systems, apparatuses, applications, or some combination thereof. Aspects of the present invention enable a wagering platform, descriptions and examples of which are provided here. Aspects of the present invention advantageously enhance competitiveness and enjoyment by players of both “e-games” or “real world” games through selected side games, skills challenges and/or wagering. For example, these elements may be offered or presented via the creation of an unlimited number of wagering-enabled side games or skills challenges related to electronic/computer-based games like “DOTA”, “Fortnite”, etc., and existing real-world games, as such but not limited to, golf, billiards, or darts. Games, skill challenges, and wagers are generally governed by contractual rules to achieve an outcome. Legal contracts are governed by human enforced rules to achieve an outcome. In this vein, smart contracts autonomously and automatically manage and enforce rules to achieve an outcome. If the rules of games, skills challenges, and wagers are converted into smart contracts, they can be managed autonomously, fairly, accurately, and securely. Furthermore, smart contracts running on blockchain networks have significant potential to increase efficiencies, increase privacy and security, and reduce transactional costs across all of gaming. Smart contracts effectively minimize counter-party risk and provide transparency in game management. Smart contracts that manage game rules and outcomes can dramatically increase the fun, security and integrity of a game by automating the various aspects of the game, score keeping, and wagering.

These elements may be provided via a game creation “gaming contract engine” (GCE), according to aspects of the current invention. (See FIGS. 1-3, 18). By way of demonstration and not limitation, these elements may be selectively offered through specific GCE-enabled software routines in a standalone software game, via a standalone software application like a golf wagering app, via remote or local API calls, other appropriate means or methods, or some combination thereof. Games created with this GCE may include, but are not limited to, standardized rules from existing side games like the golf related games “Nassau”, “Wolf', or Dots”, or they may be unique, one-off wager-based games or skills challenges, other types of games, or some combination thereof. Use of the GCE and associated technologies allows rapid creation of individually unique games, challenges, and wagers, simple execution and management of those games, and increased integrity of game outcomes since all transaction and associated game rules and actions are immutably ledgerized in a blockchain and are secure, pseudonymous, and auditable.

Additionally, aspects of the present invention advantageously create, among other things, a repository of generated games and challenges that players can access or share for play at a future date. For example, once a game has been created using a GCE-enabled application and registered as its own smart contract, it may be stored in a library of games that can be reused by the creating/initiating player or other players who have access to the library. These games may be designated as private or public games. Games may be offered to the public for free or can be sold or subscribed to via a proprietary games marketplace.

### BRIEF DESCRIPTION OF THE DRAWINGS

FIG. 1 illustrates one or more aspects of an exemplary GCE gameplay and creation process and functionality, according to various aspects described herein.

FIG. 2 illustrates one or more aspects of an exemplary GCE creation process and functionality, according to various aspects described herein.

FIG. 3 illustrates one or more aspects of an exemplary gameplay process and functionality, according to various aspects described herein.

FIG. 4 illustrates one or more aspects of core GCE systems, processes, and associated functionality, according to various aspects described herein

FIGS. 5A-5C illustrate one or more aspects of an exemplary integrated game process and associated functionality, according to various aspects described herein.

FIGS. 6A-6C illustrate one or more aspects of an exemplary GCE use scenarios, use cases, and associated functionality, according to various aspects described herein.

FIG. 7 illustrates one or more aspects of an exemplary GCE creation/selection process and functionality in a simplified format, according to various aspects described herein.

FIG. 8 illustrates one or more aspects of an exemplary GCE gameplay process and functionality, according to various aspects described herein.

FIGS. 9A-9Z illustrate one or more aspects of an exemplary mobile application, including but not limited to, GCE creation, selection, and/or gameplay process and functionality, according to various aspects described herein.

FIG. 10 is a block diagram illustrating an example of a suitable computing system environment in which aspects of the present invention may be implemented.

### DETAILED DESCRIPTION

In the following description of the various embodiments, reference is made to the accompanying drawings, which form a part hereof, and in which is shown by way of illustration various embodiments in which features may be practiced. It is to be understood that other embodiments may be utilized and structural and functional modifications may be made.

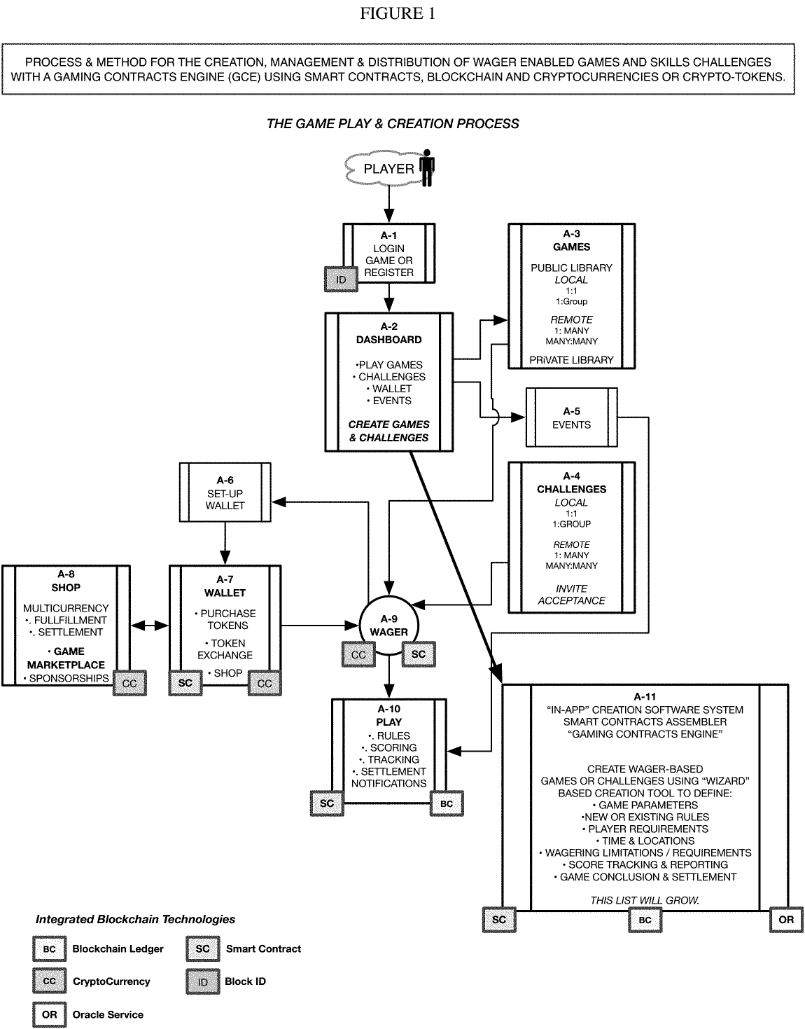

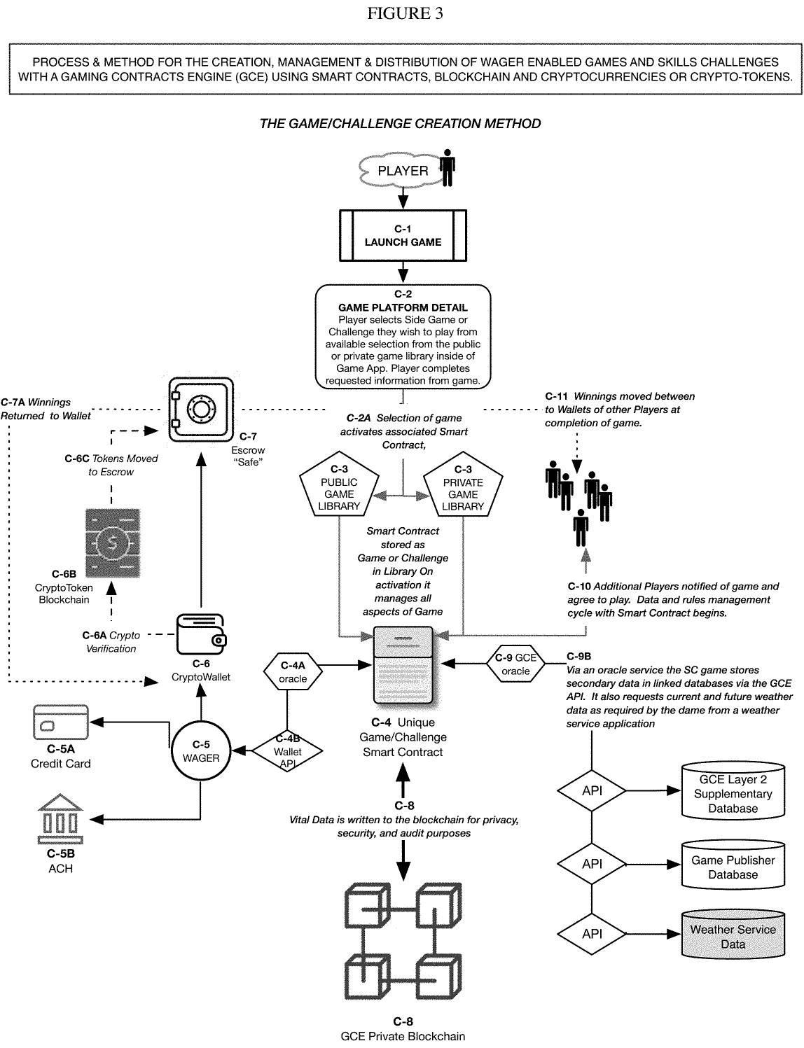

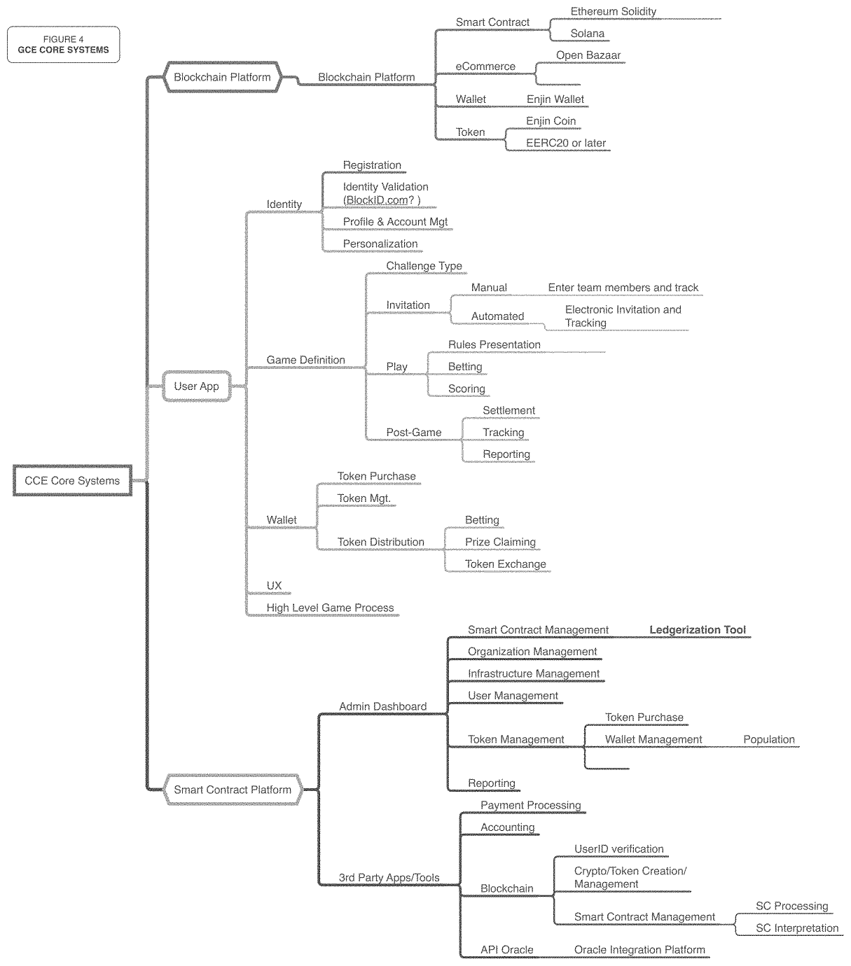

According to aspects of the present invention, one or more methods, systems, apparatuses, applications, or some combination thereof, comprise an exemplary gaming contract engine (“GCE”)(see FIGS. 1-8). One or more aspects of an exemplary application are described herein. One or more aspects of an exemplary backend system are described or illustrated herein as well.

As noted above, aspects of the present invention enable a wagering platform, descriptions and examples of which are provided here. Aspects of the present invention advantageously enhance competitiveness and enjoyment by players of both “e-games” or “real world” games through selected side games, skills challenges and/or wagering. For example, these elements may be offered or presented via the creation of an unlimited number of wagering-enabled side games or skills challenges related to electronic/computer-based games like DOTA, World of Warcraft, etc., and existing real-world games, as such but not limited to, golf, billiards or darts. These elements may be provided via a game creation “gaming contract engine” (GCE), according to aspects of the current invention. By way of demonstration and not limitation, these elements may be selectively offered through specific GCE-enabled software routines in a standalone software game, via a standalone software application like a golf wagering app, via remote or local API calls, other appropriate means or methods, or some combination thereof. Games created with this GCE may include, but are not limited to, standardized rules from existing side games like the golf related games “Nassau”, “Wolf', or Dots”, or they may be unique, one-off wager-based games or skills challenges, other types of games, or some combination thereof.

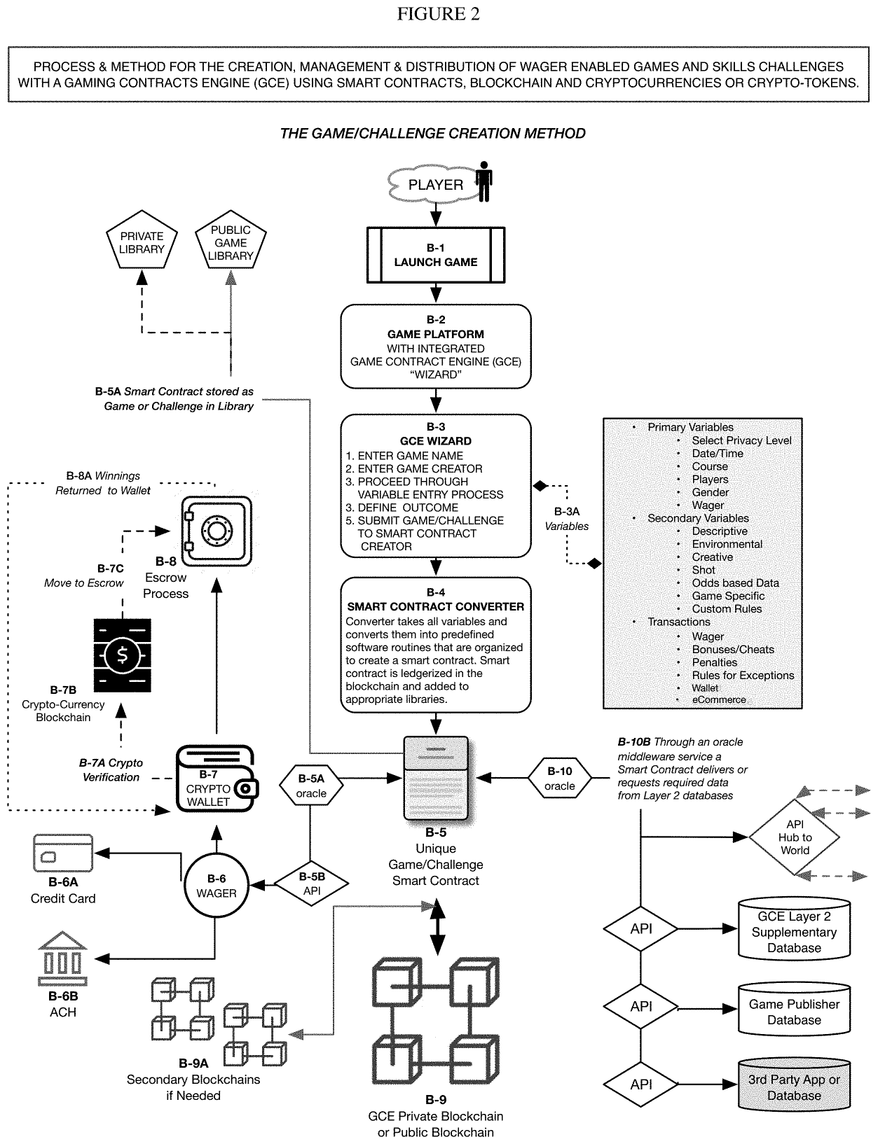

For example, games or challenges may be created by an individual player for their own use, or for distribution to others, using proprietary “wizard-based” GCE enabled software, or some combination thereof. (See FIGS. 2, 4, and 7). Additionally, each new game or challenge may be automatically assembled from individual game rules set by an existing game, or invented by a game creator, and converted via software libraries and proprietary algorithms into “smart contracts”. Once the smart contract has been created (see FIGS. 1, 2, 4, 5, and 7), it may be recorded in a public or private blockchain (or other appropriate ledger) to assure ledgerization and auditability of all game rules and associated wagers. In some embodiments, wagers may be included as game rules and the smart contract may transact fiat, stable coin, exchange-based crypto-currencies, non-fungible crypto-tokens (NFT), or other appropriate wagering unit(s). According to aspects of the present invention, the smart contract may, during play, monitor execution of the appropriate rules as they pertain to the associated wagers and record actions or other appropriate data to the associated blockchain or “oracle” (middleware software that may connect other data sources to the blockchain) linked-database or datastore via API (or other appropriate means or method) for recording data that is incidental to the execution of the game and need not be recorded to the blockchain. (See FIGS. 1-8).

According to aspects of the present invention, a smart contract may manage appropriate aspects of the game, including but not limited to, escrow of the wagered currency/token/unit until the game or specific challenge has completed. For example, a GCE-created smart contract may, among other things, manage rules and wagers during game play, determine data to be distributed to supporting databases or systems (via API or other appropriate mechanism), validate compliance of game rules, manage requests for data from 3rd party systems through an “oracle”, execute rules as required from the data received, determine winners and losers based on the rules programmed into the smart contract, other appropriate functionality, or some combination thereof. In this example, once winners and losers have been determined, the smart contract may automatically and autonomously withdraw wagered currencies (fiat, crypto, NFT, other appropriate unit, or some combination thereof) from an escrow account or directly from the loser(s)'s account(s) and distributes them as winnings to one or more digital wallet(s) of the winning player(s). In some embodiments, aspects include one or more integrated, secure digital wallets. The smart contract then closes and records the appropriate aspects of the contract as complete and distributes data as needed for, among other things, reporting and analytics.

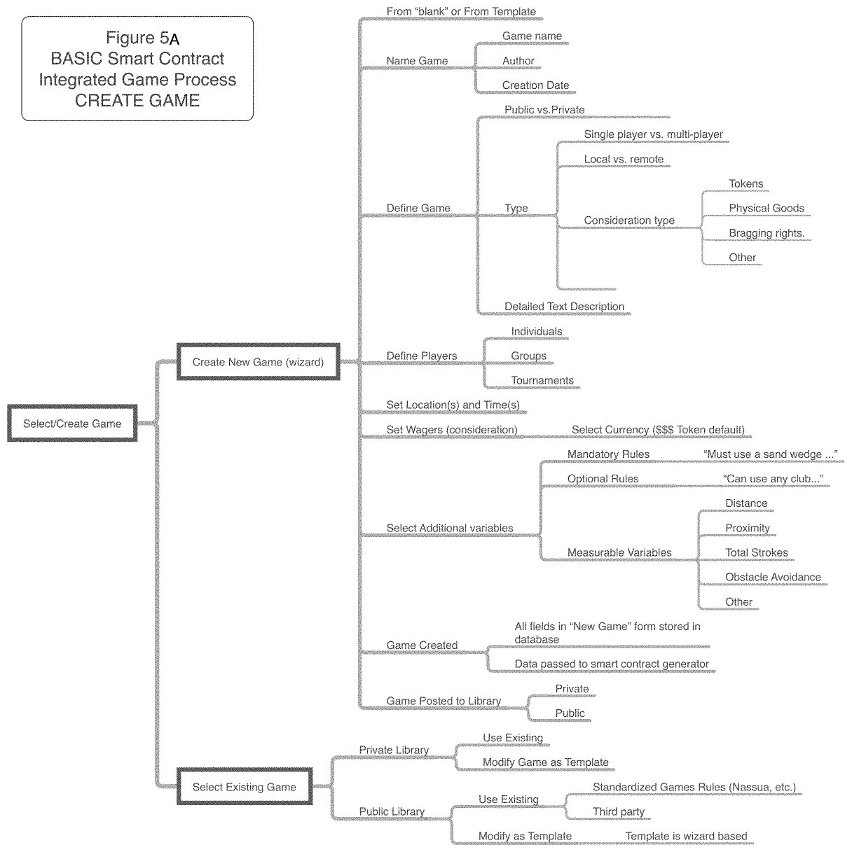

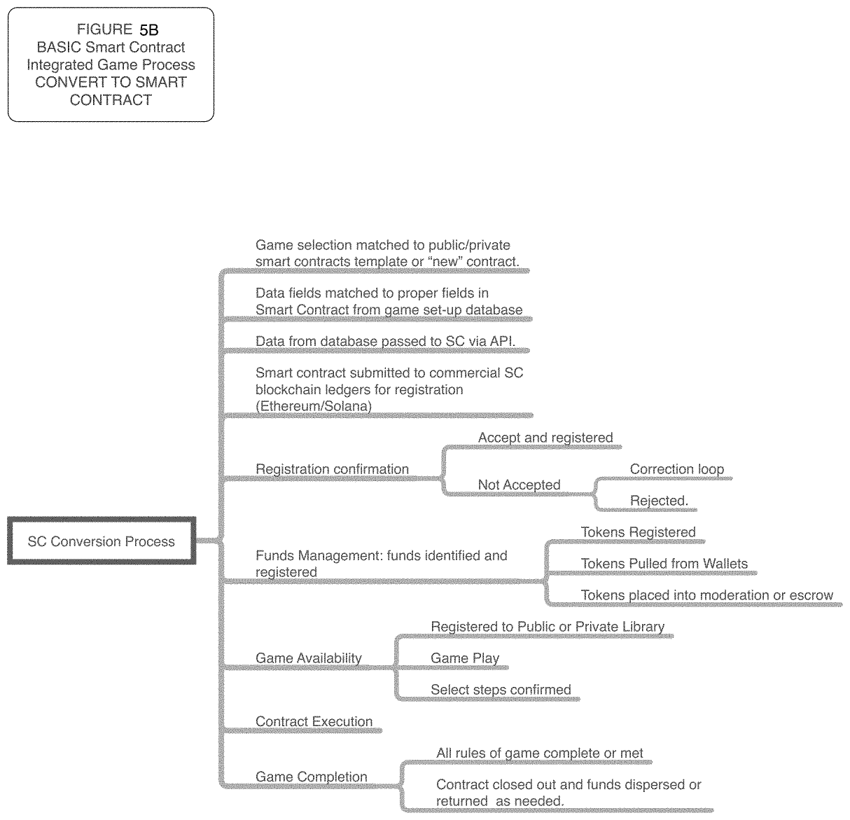

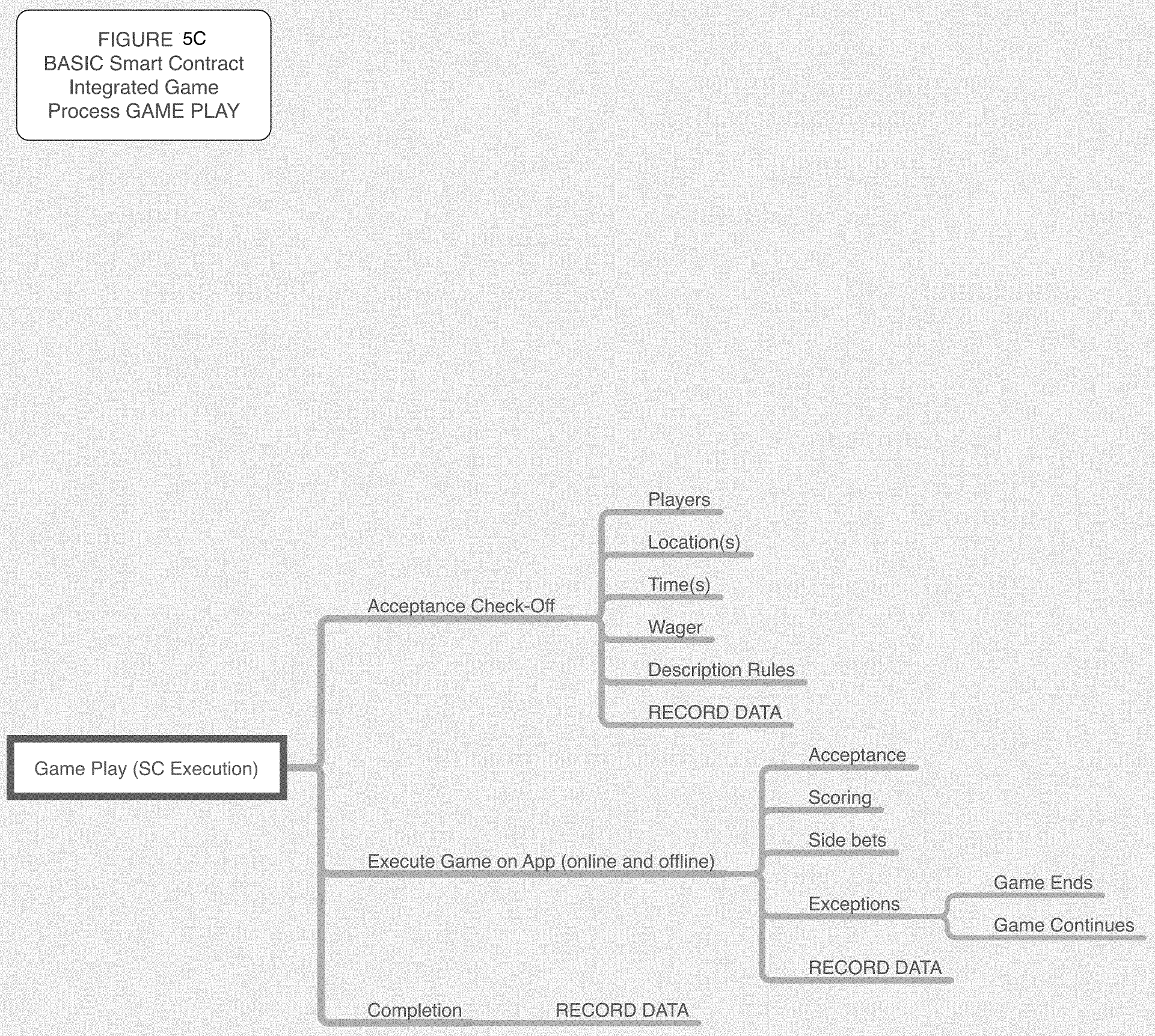

According to aspects of the present invention, in some embodiments, the processes, methods, and systems described and illustrated herein enable side wagers. (See FIGS. 5, 6, and 8). For example, one or more processes that creates a new game may be utilized to create an “addition” to an existing or newly created game known as a side challenge (a “side bet” or “side wager”). Generally speaking, a side challenge is a single event-based supplementary process or smart contract whose outcome is selectively added into an existing game as a one-time event/transaction. Settlement of one or more side wagers may occur upon completion of the side challenge and may be selectively added or subtracted from the total of the game. According to aspects of the present invention, side wagers may be played locally, remotely, or some combination thereof.

According to aspects of the present invention, in some embodiments, the processes, methods, and systems described and illustrated herein enable remote game play and wagering. (See FIGS. 1-8). For example, one or more processes included in GCE-enhanced smart contract-based games or wagers may uniquely allow for remote play in real world games that are currently local-only, e.g., municipal basketball or baseball games. But prior to the inventive elements described herein, most skills challenge or wagers must be played or offered during simultaneous play at the same physical location and same game time period. For example, golfers need to be on the same course playing with the same players at the same time to issue skills challenges or make wagers between participants. Utilizing aspects of the present invention, GCE-enabled games allow players to, among other things, digitally challenge other players who may be playing the same or similar game at a different location and/or time. GCE-enabled smart contract advantageously manages the appropriate aspects of the game including, among other things, rules and compliance, score tracking, wager management, distribution of winnings even when the players are thousands of miles and/or days apart, or some combination thereof.

Furthermore, aspects of the present invention enable, among other things, wagers based on calculated odds from game-related wagers. (See FIGS. 1-8). For example, as players play games created with the contract engine, the GCE processes and functionality may collect and store data in the blockchain or “oracle” linked database, e.g., based on rules associated with the game, data for all games or some subset thereof, etc.). In some embodiments, this data may be used to, among other things, assist the player in the future to improve the quality of their skills challenges and wagers based on calculated odds. In one example, a collected data type may comprise a specific single measured activity by one player, e.g., a series of shots in golf such as “putts”. This data may then be utilized to selectively assist a player in creating a wager where his odds of making a specific type of putt are better (or other adjusted) compared to his competitor.

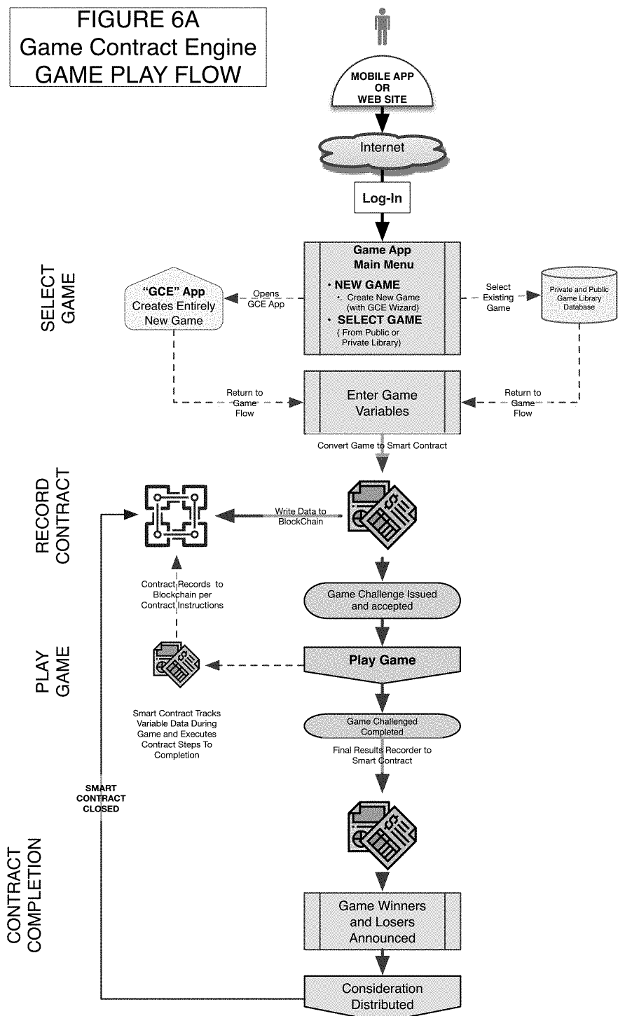

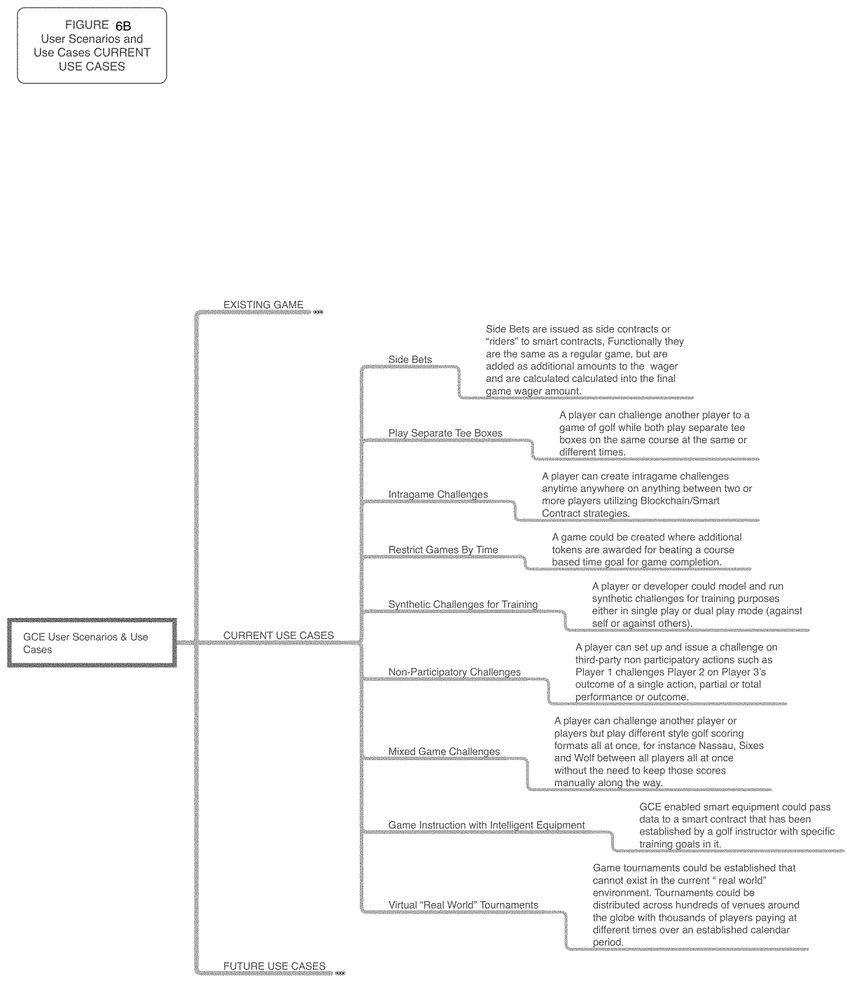

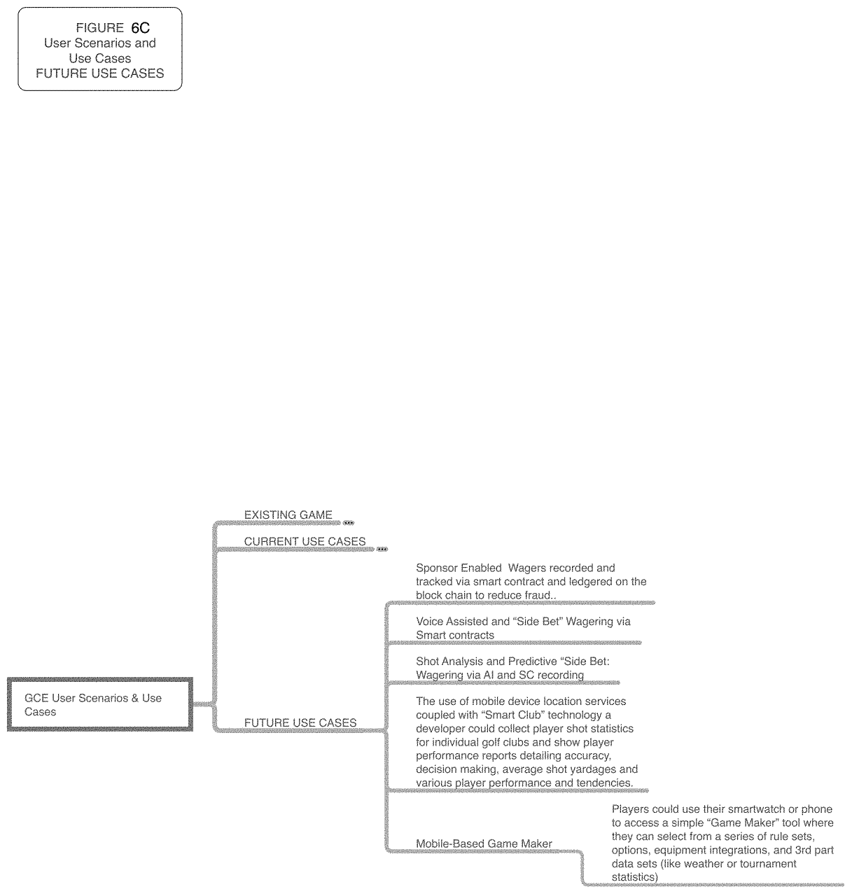

Furthermore, aspects of the present invention enable, among other things, voice-activated challenges and/or wager that create smart contracts (e.g., FIG. 6) For example, voice-to-text processes or functionality may be utilized to select or otherwise enable smart contract “boilerplate” components using the GCE into a specific wager, which may be then recorded on a blockchain (or other suitable distributed ledger), and autonomously/automatically executed to meet the criteria of that specific challenge or wager. In some embodiments, these smart contracts may be created directly from voice requests through a phone, watch, other suitable device (e.g., Internet-connected tablet or other Internet-connected device), which may, in some embodiments, be confirmed by integrated voice-matching or other biometric identification. The request may then translated by voice-to-text, e.g., via AI-enabled software like IBM Watson Voice, into a wager-specific smart contract that, among other things, manages the game or wager from additional data coming from player voice input entered via their device, e.g. their watch, phone, tablet, etc.

Furthermore, aspects of the present invention enable, among other things, a blockchain ledgerized auditable game action and activity tracking, recording, and/or analytics. (See FIGS. 1-8). For example, these element(s)/feature(s) may utilize positional/rotational/dimensional data from a player and/or his device(s). This data may include information provided by or obtained from a gyroscope, GPS systems, accelerometer, altimeter, time tracking and biometric tracking information, other suitable data, or some combination thereof, coming from a player's phone, vehicle, watch, smart equipment, game pieces, smart clothing, smart venues, etc., or some combination thereof. In some embodiments, the data may also include data from third-party or external tracking/data services that aggregate smart data, GPS, time information, and other positional/dimensional information. This data may be managed by the smart contract(s) and/or utilized to track vital player statistics, skills, activities, etc., utilized an immutable/auditable ledger. Optionally, non-vital data may be directed by one or more linked “oracles” to store or redistribute data and/or associated results to game-related databases that may be utilized to, among other things, present information, associated reports, and/or analytics. By way of demonstration and not limitation, these elements may be utilized to provide detailed game activities or skill tracking (e.g., for handicapping), game-related skills development, intelligent wagering, anti-cheating, other data-driven activities/processes, or some combination thereof

Additionally, aspects of the present invention enable, among other things, GCE-enabled games, challenges or wagers with embedded fraud-proof advertising or sponsorship-enhanced wagers. Since smart contracts are able to request or return associated information from or to other sources, they may selectively include information/data provided by sponsors and/or advertisers. For example, the information provided may comprise a simple advertisement embedded in a game that may be tracked each time a player views, responds to, or otherwise interacts with it. In another example, the information may include the provision of additional tokens to game participants or a challenge winner as motivation for the player to remember or try an advertiser's product/service. Since interactions may be measured and/or stored in a very secure and highly authenticated way, the GCE may offer quality marketing data to partnering advertisers or other parties as appropriate. Furthermore, event and fundraising sponsorships may utilize GCE-enabled games/challenges to, among other things, event venues and not-for-profit organizations to create highly engaging fundraising events that may create additional revenue through wagering and integrated advertising while dramatically increasing the number of players who may participate, as GCE-enabled games/challenges are not limited by location or time constraints. For example, the Alzheimer's Association could sponsor a celebrity golf event where thousands of players paying $50 each compete simultaneously or over the period of a week at a thousand different courses against a foursome of the best senior golfers, such that the players could issue side challenges to their team mates and competitors and the revenue from those challenges would be shared as appropriate.

Continuing, aspects of the present invention enable, among other things, GCE-enabled “single task” applications. In some embodiments, the GCE may be utilized to create, among other things, “lightweight” single task only applications. For example, a GCE-enabled app could be designed or otherwise enabled that only utilizes or otherwise incorporates a very limited number of rules from the GCE's rules library, e.g., wagering rules only. In one example, a simple app may be created that would allow “spectators” of a darts game to place very simple, fixed-amount wagers with other spectators during a contest, moments before a specific event is set to occur, e.g., a final throw or total score. The app may be “geo-fenced” to maintain legality of the wager in specific jurisdictions. The wager would, generally speaking, be a very quickly-executed smart contract and would record the legality of the wager, e.g., location of the spectator, location of the event, etc., as well as outcomes to the appropriate blockchain or ledger, and manage movement of winnings after completion of the event. Data from the blockchain/ledger may be subsequently utilized in the event of an audit of the app, its associated data, a particular player or set of players, e.g. by the state's gaming commission.

Furthermore, aspects of the present invention enable, among other things, GCE specific/integrated for promotional or specific use. (See FIGS. 6B, 6C). In some embodiments, GCE hardware may be created, assemble, or otherwise utilized for promotional purposes. For example, a golf cart manufacturer may want to offer a cart-mounted tablet that featured ten specific GCE-enabled games. Each game may be unique to the manufacturer and pertain only to these specific devices. Players would play games that used a manufacturer's (or partnering sponsor's) own unique token for play, such that winners would be allowed to “cash-in” their tokens at the end of their golf game for the appropriate “prize” or payout, e.g., sponsor goods, drinks at the club house, etc. Various aspects/information/data may be managed by one or more associated smart contracts, where the key data that was registered on the blockchain may be utilized to validate the transaction as fraud-proof and auditable. By way of demonstration and not limitation, an example of a specific use may include an “anti-cheating watch”. In this example, a GCE-enabled smart watch-based app may be created that may contain a single wager-based golf side game designed for remote play. A primary difference of this example from other games described herein is that the game's associated smart contract may request considerable supporting information from the watch while enforcing the rules. For example, the smart contract may use watch accelerometer information to determine, among other things, if a swing makes contact with a ball or if it was a “practice” swing, or if a ball is tossed or thrown. In some embodiments, the smart contract may request continual GPS information and pass the data on to an app that looks for movement anomalies that would suggest illegal foot-induced ball movement or “extra” putts. It may also compare highly detailed GPS course maps to locations of boundaries to determine out-of-bounds status. It may also request biometric information that could be indicative or suggestive of cheating, e.g., breathing irregularity, increased BP, voice stress, changed galvanic skin response, etc. Anomalous data would be posted or otherwise recorded (with rules infractions, if desired) to the blockchain. Supporting information may additionally be stored in associated tracking databases to build incident libraries and improve accuracy of measurement.

Furthermore, aspects of the present invention enable, among other things, “LAYER 2” enhanced game & transaction tracking. (See FIGS. 1-8). Generally speaking, this refers to secondary applications (databases) or channels that are built on top of the main blockchain and do not require any fundamental changes to the actual blockchain for proper operation. In essence, the bulk of transactions are ‘off-loaded’ to these secondary channels (layer 2) to reduce network congestion and facilitate faster processing speeds. To enable Layer 2 capabilities, a middleman or “oracle” manages the links and data movement between the blockchain and the required and related applications. One of skill in the pertinent arts is aware of the growing need for external data flowing into blockchains and, by extension, smart contracts has led to the growing need for oracles. Broadly speaking, oracles are proprietary (or 3rd party) data feeds, that may need permission from external entities, that feed vital information into blockchains which smart contracts may need to execute under specific conditions. The growing need for oracles represents the continued expansion of blockchain systems into practical and real-world use cases, i.e., aspects of the present invention (GCE), where accurate data is crucial. With Layer 2 capabilities smart-contracted executed transactions are tightly integrated with the blockchain records, such that the user receives similar security protections as with on-chain transactions, as the blockchain acts as the anchor of trust via its immutable structure. Layer 2 integration with the GCE allows a smart contract to determine which data needs to be permanently and immutably recorded to the blockchain versus which data is transitory, or of lesser importance, and may be recorded into associated applications or databases.

By utilizing oracle-based middleware (preferably distributed), the smart contract may push or pull data via the GCE (e.g., via API or suitable call) into, or from, one or more appropriate applications as needed. (See FIGS. 1-8). By way of example and not limitation, these elements may be utilized for recording purposes—as a player plays through a round of golf and completes each hole, the score for the hole is scored and tallied. The individual score of each hole is generally not important and can be exported via API to be stored in another application that manages a player's profile (e.g., scoring history). However, the tallied scores and total score is integral and needs to be validated and ledgerized, and thereafter kept for reporting to the PGA or other governing authority/body, to calculate accurate player indexes. In an example of requesting data (e.g., via API) to validate a game rule event, a smart contract for a golf game may include, among other things, a rule that says games not completed by sundown will be considered “incomplete” and “canceled”, such that all funds escrowed for wagers are to be returned to the appropriate participants. At the time of game start, the smart contract may request data from an appropriate weather database for the time of sundown, and may then automatically cancel the game at the official sundown time. As should be apparent, the date is required to execute the contract, but may not be considered necessary for recordation into the blockchain record.

Advantageously, according to aspects of the present invention described and illustrated herein, the methods, processes, and systems described herein provide the first smart contract-based game creation, skills challenge and wager making and execution platform. The features, whether described herein or apparent from the figures and description, are unique and include, but are not limited to, game rules, issued wagers, and skills challenges may be entered into an application and are converted into a consistent and individually modeled smart contract. Contracts may then be executed based on game play data and rules and are validated, performed, and finalized including winner determination and winning distribution. Smart contracts may manage all aspects of a game including observation of rules, determination of winners, critical data may be recorded in perpetuity to a blockchain or suitable distributed ledger. Associated data may be stored in tightly linked applications or databases to reduce computational risk to the blockchain and speed processes. The GCE comprises, among other things, proprietary software code, algorithms, and processes that may be embedded in other applications or permanently stored on fixed use computer chips. As should be apparent, the GCE is not limited to specific computer hardware, software, or programming languages. Application of smart contracts for identifying anomalous gaming data may assist in maintaining game (and player) integrity.

Methods, processes, functions, and systems described and illustrated throughout advantageously provide a platform for secure, auditable, remote, custom gameplay. (See FIGS. 1-8). By way of demonstration and not limitation, the GCE may produce existing or uniquely created games, skills challenges, and/or wagers inside of a new/existing app, where any player may creates games or issue challenges/wagers and issue them digitally. The GCE may utilize private or public game libraries, or both. Additionally, complex or unique GCE-enhanced games and skills challenges may be sold in a marketplace for per-use or event purposes. The platform may be utilized with existing apps and games, where an app may create or use standardized rules for specific games, resulting in customized challenges if so desired. The challenges, whether public or private, may be issued 1-to-1, 1-to-many, 1-to-team, team-to-team, many-to-many, or any other suitable type of issuance. (See FIG. 1). Due to the nature of the platform, there may be unlimited participants in a single game and near real-time distribution of challenges. The platform also advantageously provides, among other things, wager management, winner identification, wager escrow, automated settlement (whether instant or delayed), unlimited currencies for wagers, remote challenges, time-shifted challenges, highly-secure/highly-accurate/auditable transactions, and integrated privacy. And for legal/regulatory compliance, the platform provides auditable acceptance, compliance, and settlement of game results.

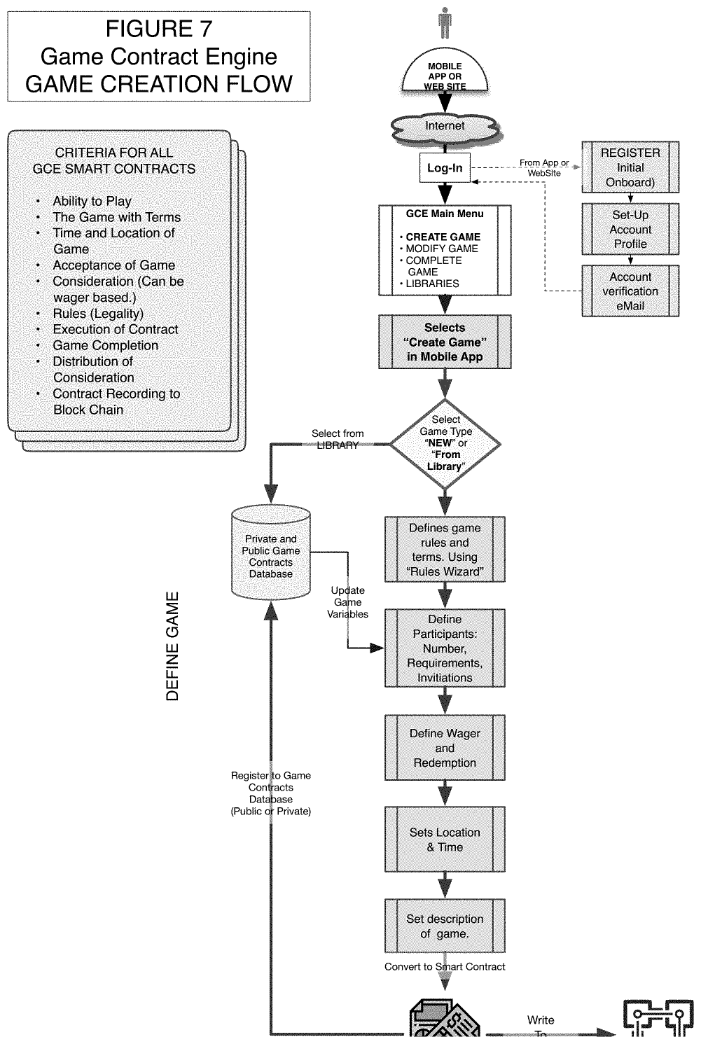

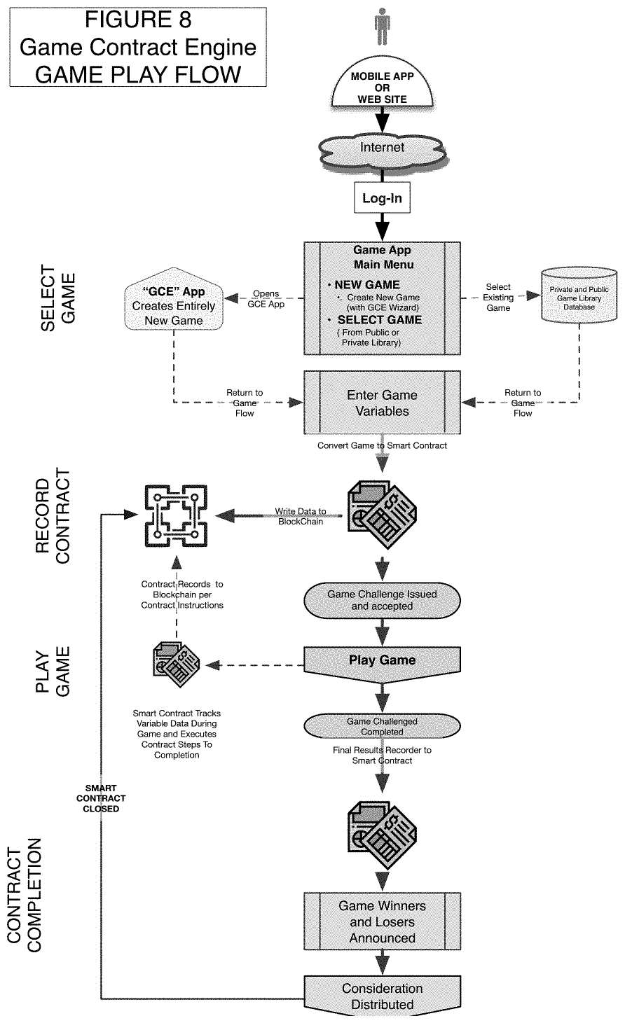

For example, FIGS. 7 and 8 illustrate exemplary simplified game creation, selection, and gameplay, according to aspects of the present invention. In FIG. 7, an exemplary GCE is initialized when a game player determines to issue a gaming challenge (game) to one or more competitors. From within a mobile or desktop app, the game player selects a game type that has already been created and stored in a public library or from their own library of created games. In the event they choose to create an entirely new game they would initiate the GCE through an app (the “wizard”) that walks the player through the process of creating a new game. Generally speaking, each game created by the GCE is its own smart contract, as smart contracts and the definition of games are interchangeable. The player continues through the screens of the wizard and as they select the predefined rules or create new ones the resultant data is added to the unique terms and code of the smart contract. Furthermore, the most basic information required for each game matches the basic requirements of contracts in general, and subsequently smart contracts. Each game must: define the participants ability to participate; the challenge; terms of acceptance; consideration (which can include a wager); the location and time of the specific game; the specific rules of play; terms of contract execution; definition and execution of completion of the game; distribution of consideration; and the terms of recording the execution of the contract to associated databases, oracles, and the blockchain. Recording execution happens continually through the smart contract execution process and is recorded to the contract defined location through each step of the contract. Upon completion of the contract all final results and execution data are recorded in the blockchain for immutability and audit purposes.

Turning now to FIG. 8, upon completion of the creation of a new game, or the selection of a game from a public or private library, a player can then play the game. Upon selection of the game, the player is prompted to complete basic information required for play. This information is required “in the background” by the smart contract for game execution. Once the game has been “set-up”, the game challenge is issued to competitors and/or other participants as defined by the game rules. Upon acceptance, game play commences. As the game progresses, specific data may be written or otherwise recorded as required by the smart contract which manages the game. This data can include almost limitless types of information, including, but not limited to; “hole-by-hole” scores, biometric data, specific geographic information, environmental data, etc. Upon completion of the game a winner is determined based on the rules and final results and execution data are recorded in the blockchain for immutability and audit purposes.

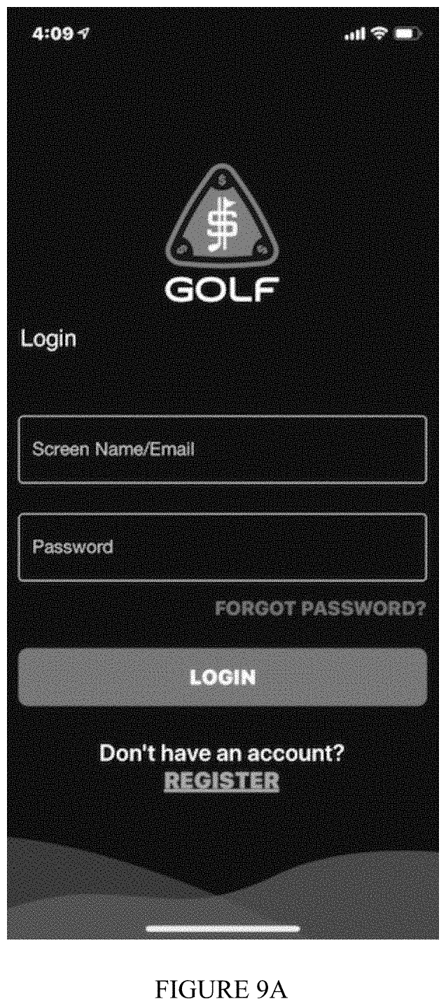

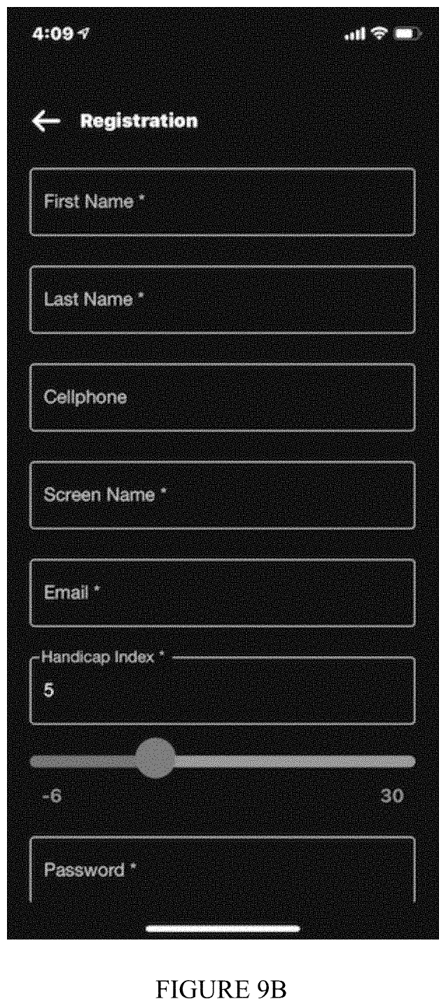

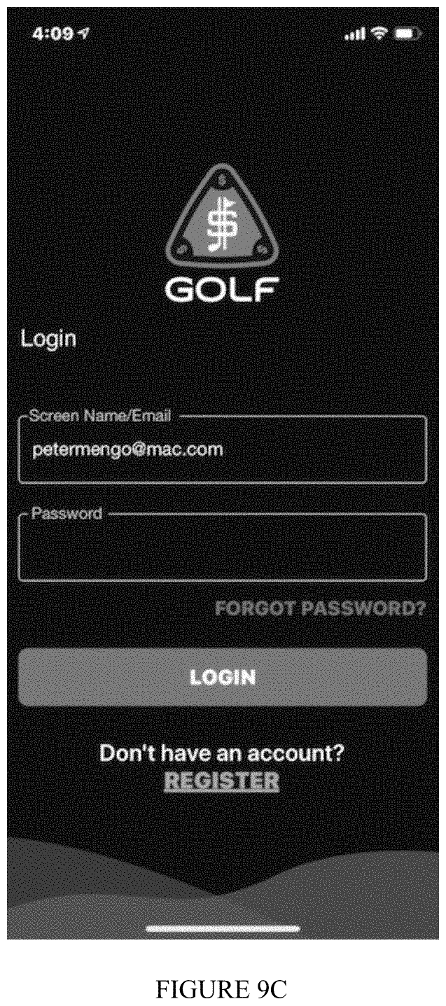

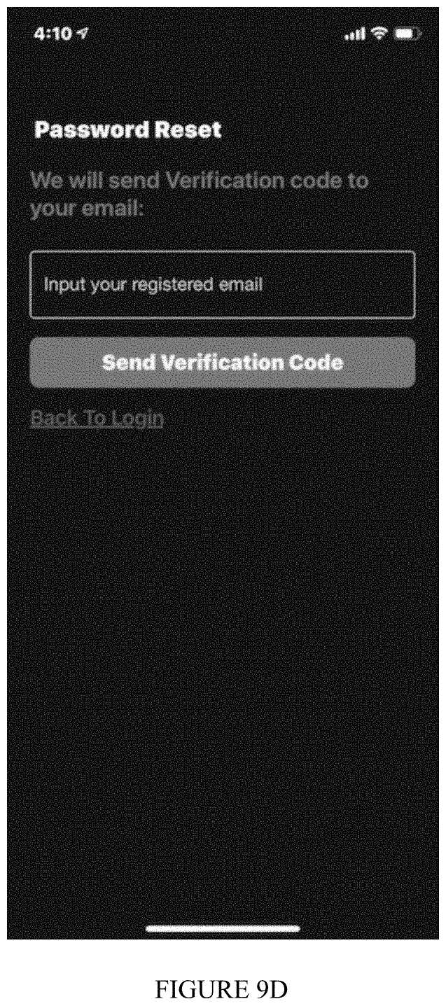

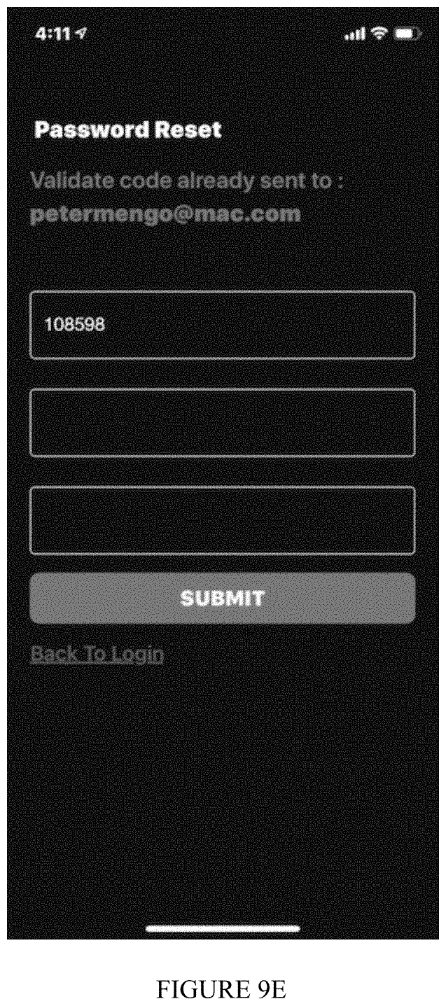

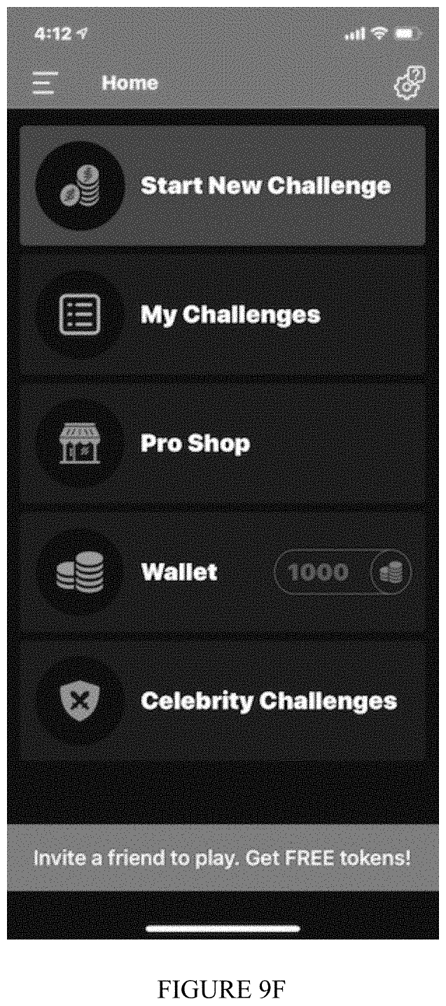

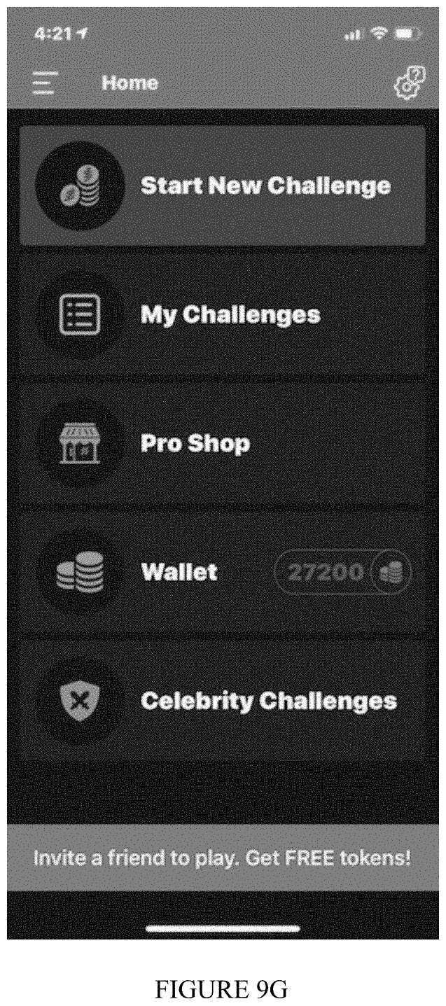

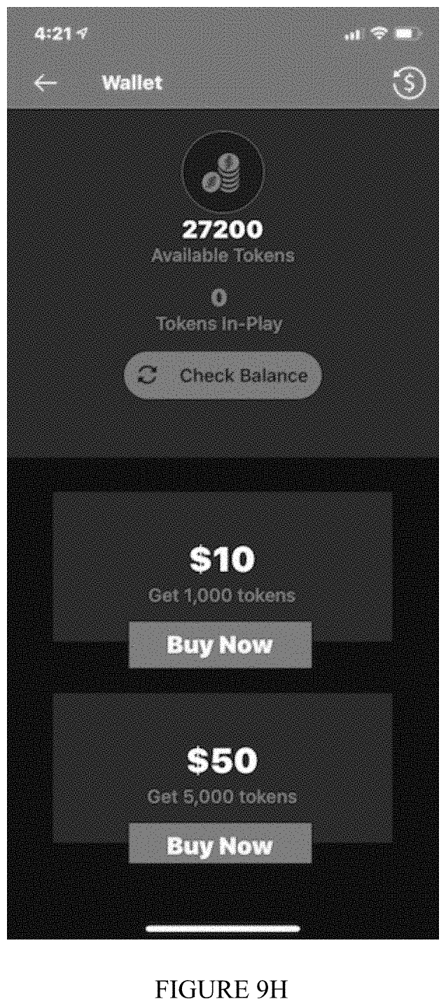

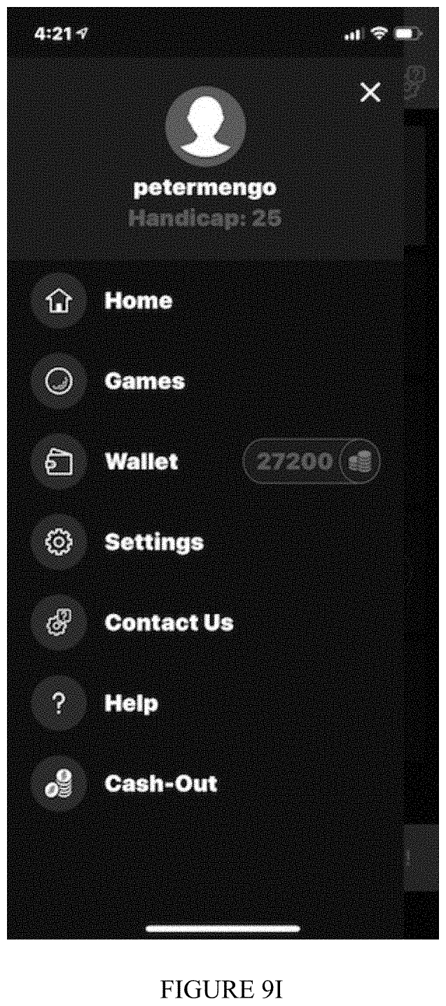

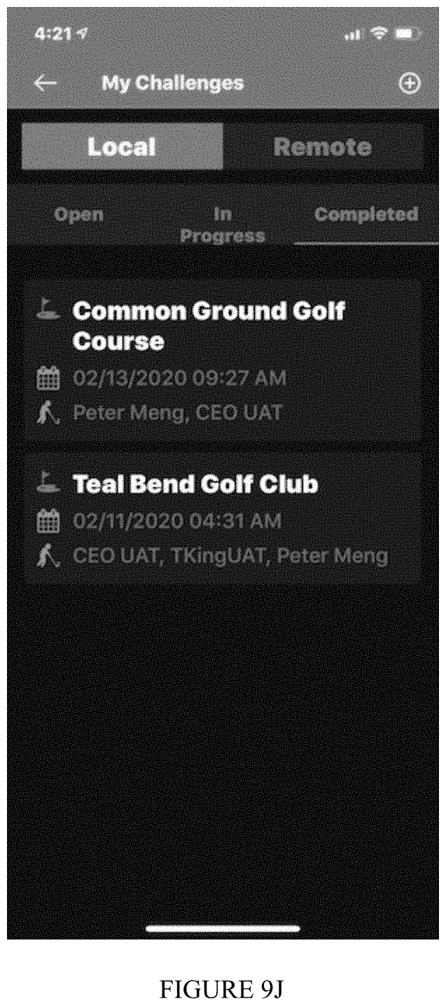

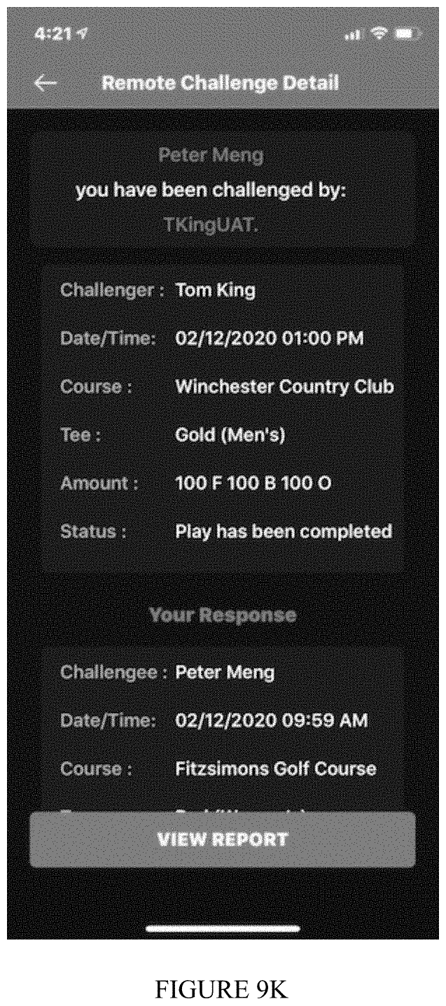

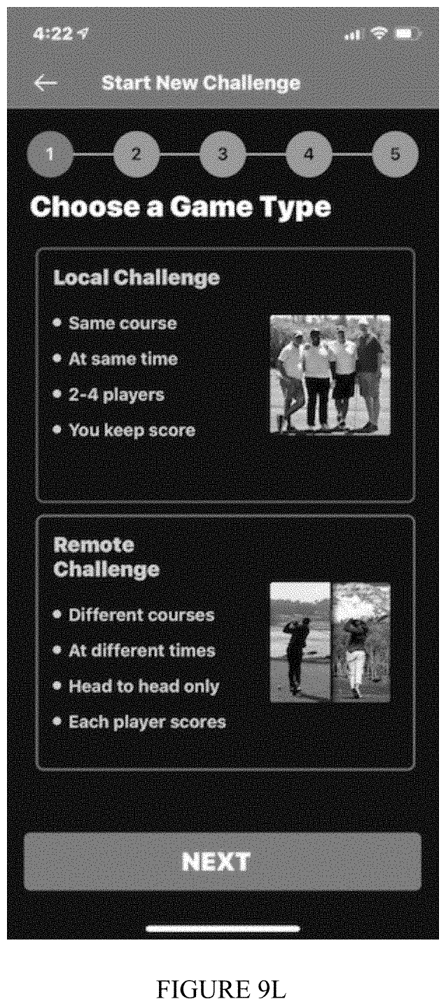

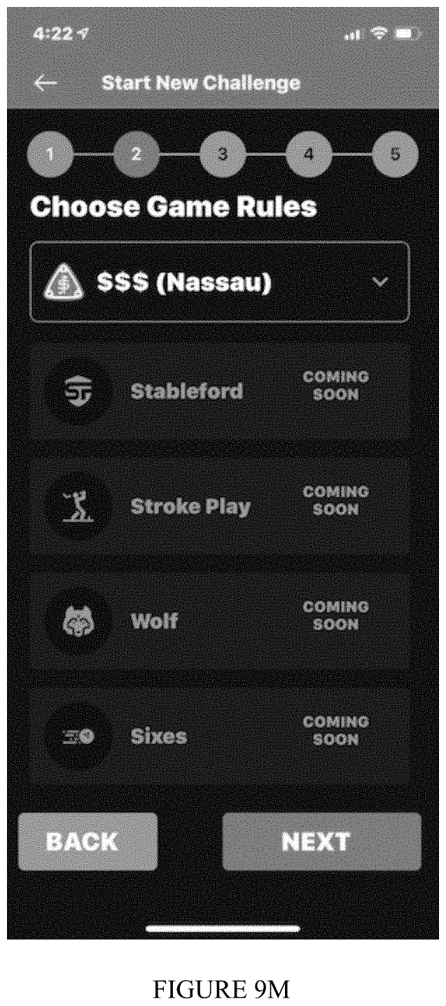

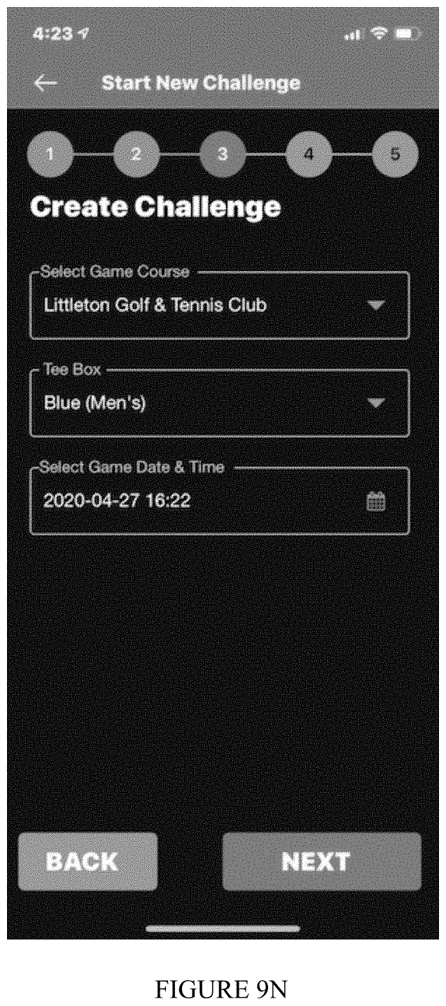

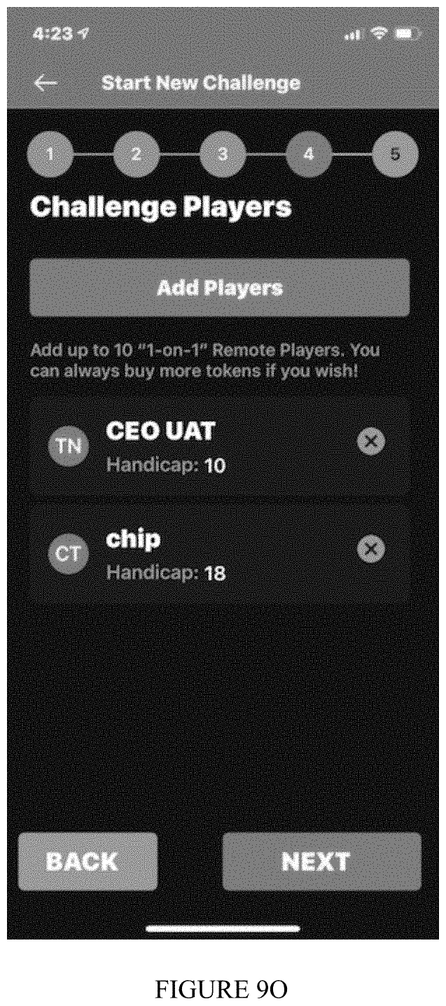

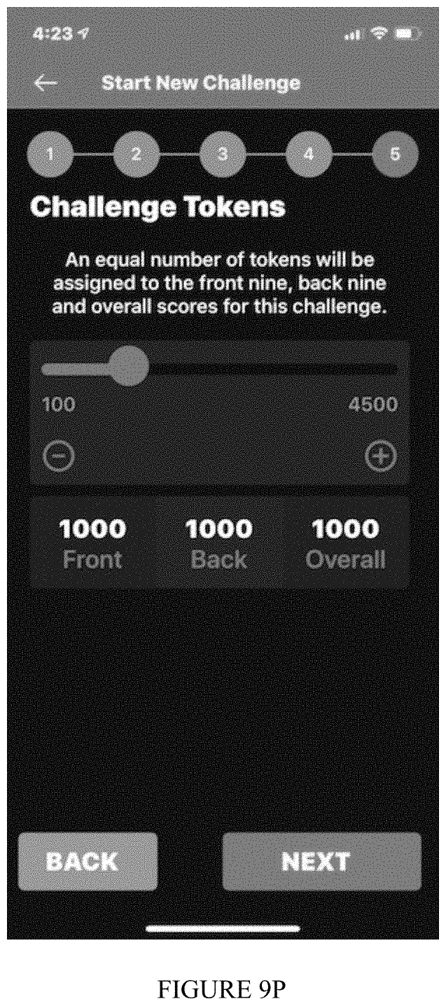

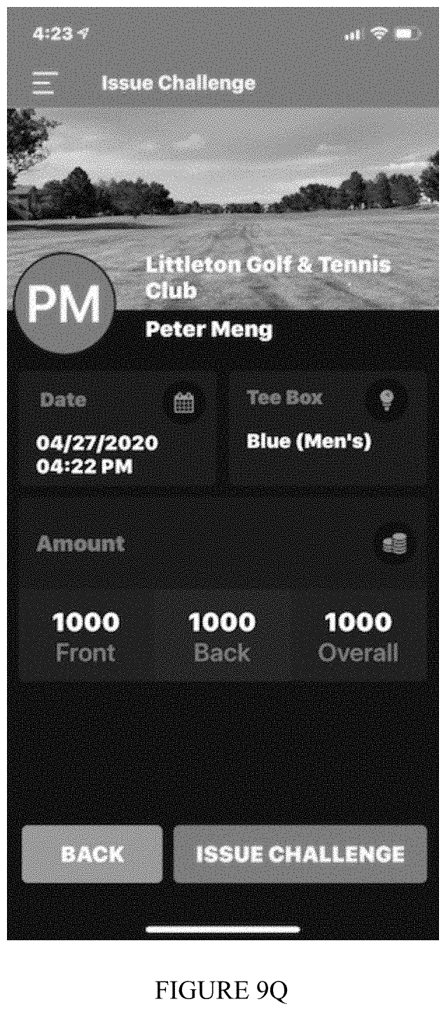

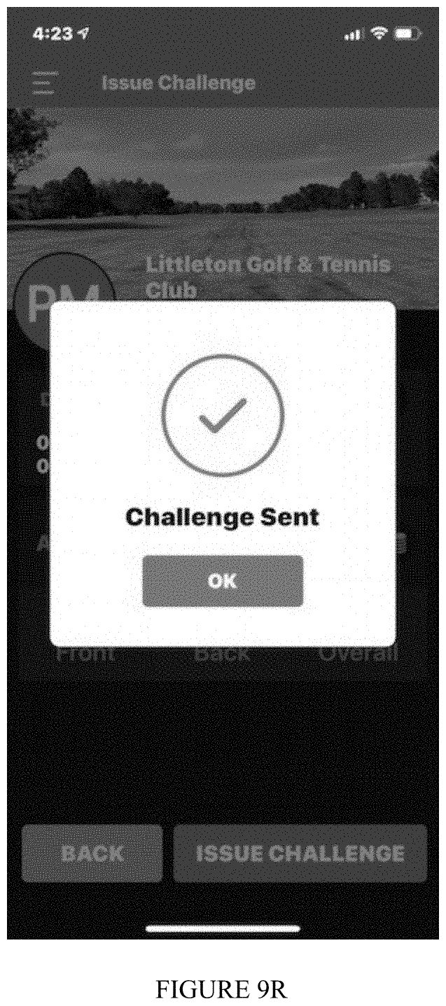

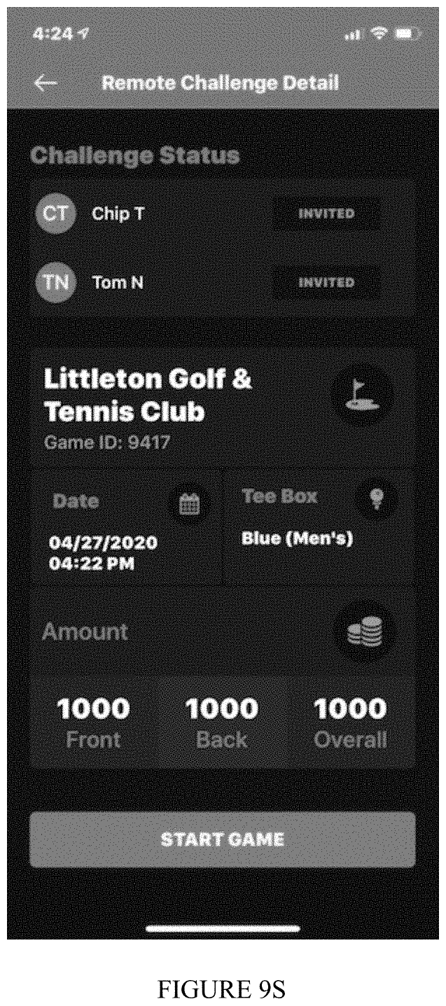

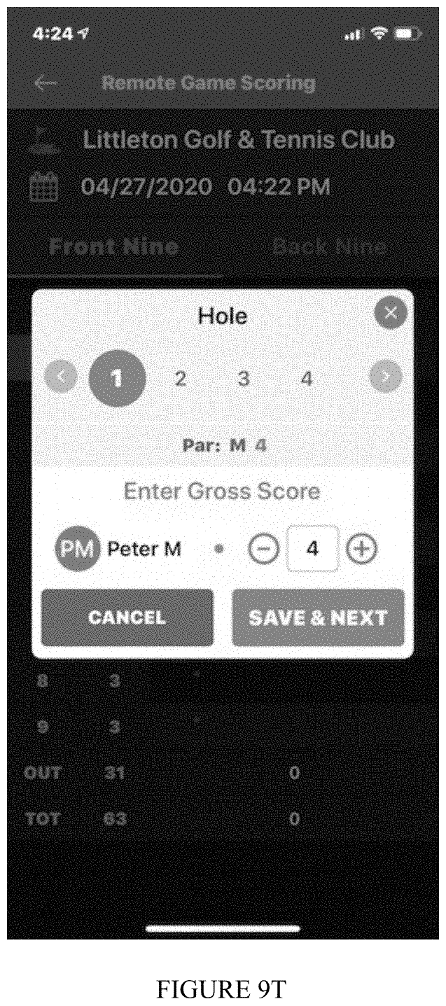

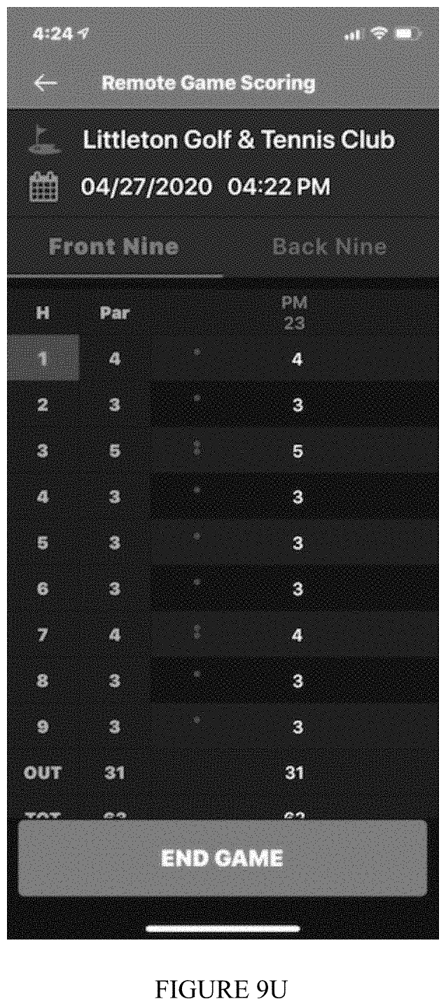

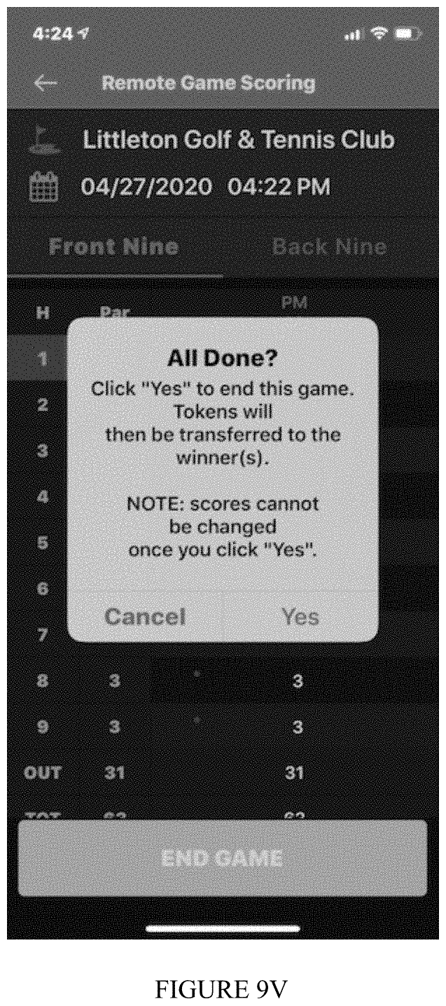

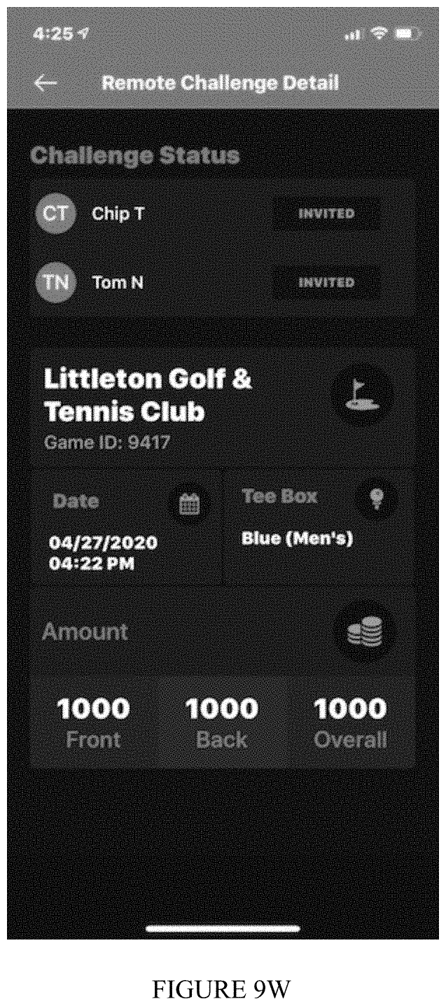

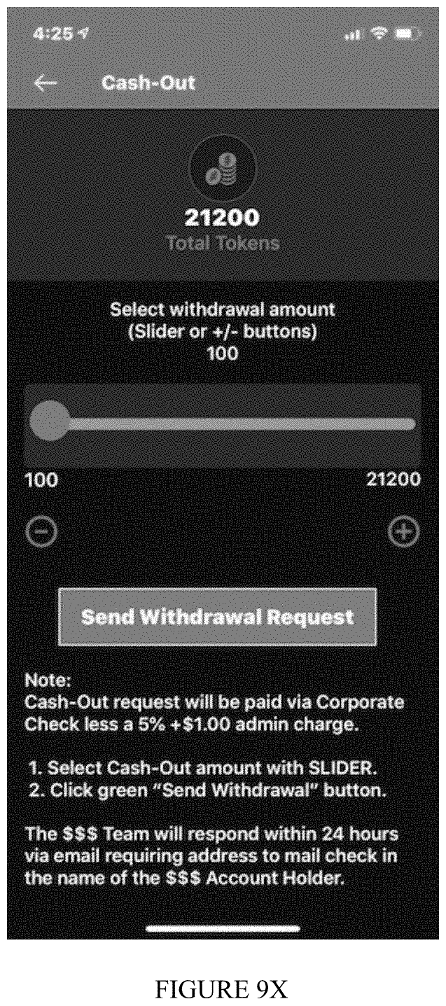

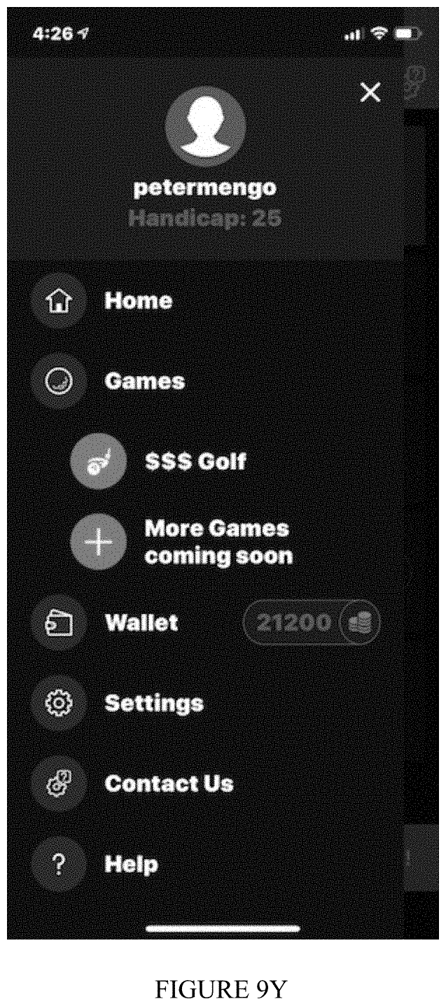

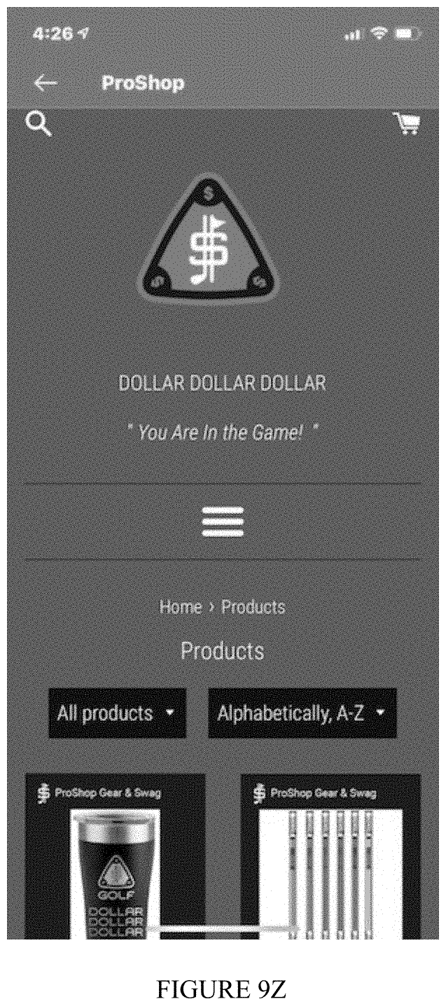

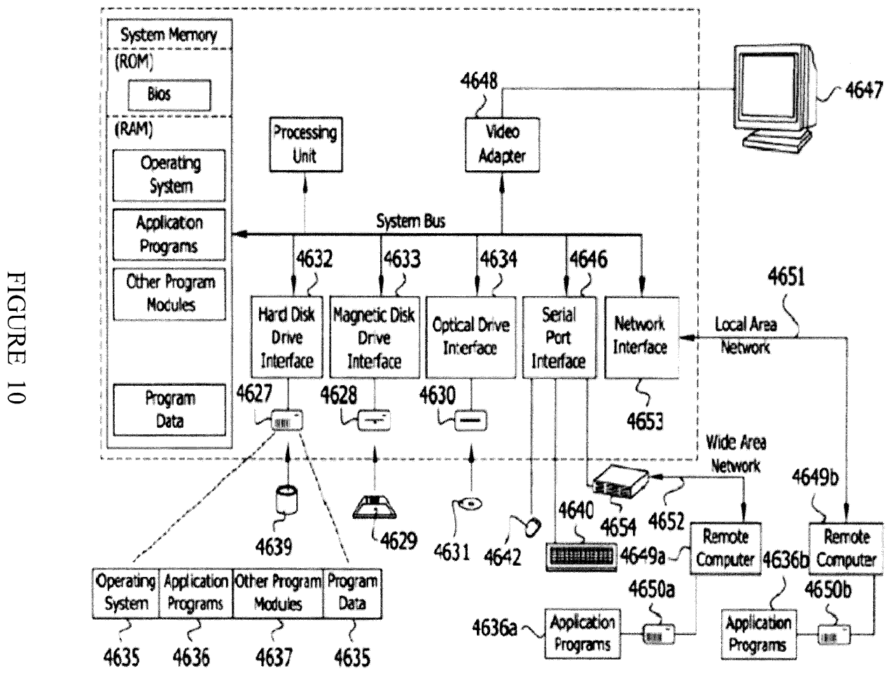

An exemplary mobile application, illustrating aspects of the present invention as described throughout, is illustrated in FIGS. 9A-9Z.

In other words, a GCE embodying one or more of the aspects described or otherwise illustrated above advantageously enables entirely new ways of gaming through new game types or new ways of playing games. For example, an exemplary GCE allows games to have new or updated capabilities, including, but not limited to: more enjoyable games, easier to play, reduced or eliminated cheating or fraud, creation of new game revenue models, integration of legal/trackable/auditable wagering; removal of limitations of time or location on games in the physical world, allowing side games and side bets; allowing simple rule changes to established games to create entirely new game; and integration of new or proprietary technologies to improve game play. A GCE may additionally be combined with additional technology to enable, among other things: ledgerized remote game play and wagering; voice activated wagers or challenges that create smart contracts; enhanced game rules & transaction tracking using data from smart equipment; game sponsorship and advertising enhanced wagers with anti-fraud tracking; proprietary GCE integrated hardware/chips; player movement and integrity tracking; ledgerized player-to-player personal wagers on 3^{rd} party games or events; voice matched ledger tracked mobile wagers; A.I. enhanced wager recommendations based on ledgerized player history, gaming data, game and environmental conditions and player wagering history. As a platform, the GCE will be unmatched in its ability to affect change on all types of real world and virtual world gaming.

One of ordinary skill in the pertinent arts will recognize that, while various aspects of the present invention are illustrated in the FIGURES as separate elements, one or more of the elements may be combined, merged, omitted, or otherwise modified without departing from the scope of the present invention.

With reference to FIG. 30, an exemplary system for implementing aspects of the invention includes a general-purpose computing device in the form of a conventional computer 4320, including a processing unit 4321, a system memory 4322, and a system bus 4323 that couples various system components including the system memory 4322 to the processing unit 4321. The system bus 4323 may be any of several types of bus structures including a memory bus or memory controller, a peripheral bus, and a local bus using any of a variety of bus architectures. The system memory includes read only memory (ROM) 4324 and random-access memory (RAM) 4325. A basic input/output system (BIOS) 4326, containing the basic routines that help transfer information between elements within the computer 20, such as during start-up, may be stored in ROM 4324.

The computer 4320 may also include a magnetic hard disk drive 4327 for reading from and writing to a magnetic hard disk 4339, a magnetic disk drive 4328 for reading from or writing to a removable magnetic disk 4329, and an optical disk drive 4330 for reading from or writing to removable optical disk 4331 such as a CD-ROM or other optical media. The magnetic hard disk drive 4327, magnetic disk drive 4328, and optical disk drive 30 are connected to the system bus 4323 by a hard disk drive interface 4332, a magnetic disk drive-interface 33, and an optical drive interface 4334, respectively. The drives and their associated computer-readable media provide nonvolatile storage of computer-executable instructions, data structures, program modules, and other data for the computer 4320. Although the exemplary environment described herein employs a magnetic hard disk 4339, a removable magnetic disk 4329, and a removable optical disk 4331, other types of computer readable media for storing data can be used, including magnetic cassettes, flash memory cards, digital video disks, Bernoulli cartridges, RAMs, ROMs, and the like.

Program code means comprising one or more program modules may be stored on the hard disk 4339, magnetic disk 4329, optical disk 4331, ROM 4324, and/or RAM 4325, including an operating system 4335, one or more application programs 4336, other program modules 4337, and program data 4338. A user may enter commands and information into the computer 4320 through keyboard 4340, pointing device 4342, or other input devices (not shown), such as a microphone, joy stick, game pad, satellite dish, scanner, or the like. These and other input devices are often connected to the processing unit 4321 through a serial port interface 4346 coupled to system bus 4323. Alternatively, the input devices may be connected by other interfaces, such as a parallel port, a game port, or a universal serial bus (USB). A monitor 4347 or another display device is also connected to system bus 4323 via an interface, such as video adapter 4348. In addition to the monitor, personal computers typically include other peripheral output devices (not shown), such as speakers and printers.

The computer 4320 may operate in a networked environment using logical connections to one or more remote computers, such as remote computers 4349a and 4349b. Remote computers 4349a and 4349b may each be another personal computer, a server, a router, a network PC, a peer device or other common network node, and typically include many or all of the elements described above relative to the computer 4320, although only memory storage devices 4350a and 4350b and their associated application programs 36 a and 36 b have been illustrated in FIG. 1. The logical connections depicted in FIG. 6 include a local area network (LAN) 4351 and a wide area network (WAN) 4352 that are presented here by way of example and not limitation. Such networking environments are commonplace in office-wide or enterprise-wide computer networks, intranets and the Internet.

When used in a LAN networking environment, the computer 4320 is connected to the local network 4351 through a network interface or adapter 4353. When used in a WAN networking environment, the computer 4320 may include a modern 4354, a wireless link, or other means for establishing communications over the wide area network 4352, such as the Internet. The modem 4354, which may be internal or external, is connected to the system bus 4323 via the serial port interface 4346. In a networked environment, program modules depicted relative to the computer 4320, or portions thereof, may be stored in the remote memory storage device. It will be appreciated that the network connections shown are exemplary and other means of establishing communications over wide area network 4352 may be used.

One or more aspects of the invention may be embodied in computer-executable instructions (i.e., software), such as a software object, routine or function (collectively referred to herein as a software) stored in system memory 4324 or non-volatile memory 4335 as application programs 4336, program modules 4337, and/or program data 4338. The software may alternatively be stored remotely, such as on remote computer 4349a and 4349b with remote application programs 4336b. Generally, program modules include routines, programs, objects, components, data structures, etc. that perform particular tasks or implement particular abstract data types when executed by a processor in a computer or other device. The computer executable instructions may be stored on a computer readable medium such as a hard disk 4327, optical disk 4330, solid state memory, RAM 4325, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

A programming interface (or more simply, interface) may be viewed as any mechanism, process, or protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the provided detailed description. Some illustrative implementations of a programming interface may also include factoring, redefinition, inline coding, divorce, rewriting, to name a few. There are, however, other ways to implement a programming interface, and, unless expressly excluded, these, too, are intended to be encompassed by the claims set forth at the end of this specification.

Embodiments within the scope of the present invention also include computer-readable media and computer-readable storage media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general-purpose computer, special purpose computer, or special purpose processing device to perform a certain function or group of functions

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing aspects of the present invention.

### EXHIBIT A

1. Any existing game (defined by it's rules) or new type of game using current digital technologies that are defined and played “engine”; (our game is a great example of taking a current game model and re-issuing it in a digital format using the rules and tools inside the engine).
2. Any existing or new type of game component or feature that uses current digital technologies we develop for the “engine” (our use of remote play using existing technologies is a great example of this); using
3. Any existing game (defined by its rules) or entirely new game using new or developing physical (smart clubs) or digital technologies that can be enhance the games developed using the “engine”. I.e., blockchain, smart contracts, digital currencies/tokens, etc.
4. Any existing or new type of game component or feature using new or developing digital technologies that are an integrated part of the “engine”. I.e., blockchain, smart contracts, digital currencies/tokens, etc.
1. With the GCE a player can challenge another player to a game of golf while both play separate courses at different times.
   a. This is Remote Play which has never been done before formally for the game of golf.
2. With the GCE a player can challenge another player to a game of golf while both play separate tee boxes on the same course at the same or different times.
   a. This has been done physically and the World Golf Governing Bodies such as RNA and USGA have a formula for course handicapping players. Our App does this electronically.
3. With the GCE and the use of mobile device location services coupled with “Smart Club” technology a developer could collect player shot statistics for individual golf clubs and show player performance reports detailing accuracy, decision making, average shot yardages and various player performance and tendencies.
   a. The intention of this output is to automatically track and supply golfers with the “automated” data about their games. Currently there are apps that require a player to input each shot (without specific distance) just have a high-level analysis of player statistics such as “Green in Regulation”, % of Fairways hit, Average number of puts. Our App will drive a deeper sense of those states by adding geolocation and distance to each shot specifically with ball tracking (flight/roll).
      i. This will enable a player to see their average 7 iron distance, flight path and height.
      ii. Not only number of puts struck but total distance of Putt's made! From this likelihood or % probability of a put being made. Since, the contour of the greens is mapped now digitally this player data could go as granular to add angle stats such as a player being better at a putt that is downhill left to right break between 5 to 10 feet in length.
4. With the GCE a player can create intragame challenges anytime anywhere on anything between two or more players utilizing Blockchain/Smart Contract strategies
   a. Smart contracts use in combined skills challenges
      i. A golfer could challenge a friend who is bowling that the bowler won't beat their average over the next three games by more then 3% and in the same challenge the bowler challenge his gold friend that his next three game would would not break par at his current handicap. The GCE could ProRate results and determine a winner.
      ii. Golf, Bowling, Ping Pong, Bag Toss, Darts, Ax-throwing; Virtually any Parlor Style game or One-on-one contest could be combined and scored and stored immutably in the blockchain.
5. With the GCE a Sports League Manager could build, track and run any sports league between individuals or teams
   a. GCE works for Team Play and Tournaments too because team lay or tournaments are simply additional rule sets that can be integrated into a Smart Contract.
6. With the GCE a player can challenge another player or players but play different style golf scoring formats all at once, for instance Nassau, Sixes and Wolf between all players all at once without the need to keep those scores manually along the way.
   a. The GCE enables the challenge creator to set up one or multiple games that all use the single performance player score/outcome across the different tabulation and rules formats simultaneously
7. With the GCE a player can set up and issue a challenge on third-party non participatory actions such as Player 1 challenges Player 2 on Player 3's outcome of a single action, partial or total performance or outcome.
   a. 3^{rd} party gaming
8. With the GCE a player or developer could model and run synthetic challenges for training purposes either in single play or dual play mode (against self or against others).
   a. What if scenarios across industries, games, leagues, players, matches based on historical data
   b. Stock Market Trade
9. With the GCE a game could be created where additional tokens are awarded for beating a course based time goal for game completion. The game would read start and stop times from a players Smartwatch and accelerometer readings from the watch (to determine an effective swing) and write the gathered data to the integrated blockchain to keep players from falsifying game play information. Matching or exceeding the established game play time would result in additional tokens being issued as a reward. Winnings could be a fixed amount or scaled based upon the length of time exceeding the specified goal.
10. With the GCE players could use their smartwatch or phone to access a simple “Game Maker” tool where they can select from a series of rule sets, options, equipment integrations, and 3^{rd} part data sets (like weather or tournament statistics)
11. With the GCE a player could create a SOLO PLAY game that awarded him tokens for winning or sent tokens to a charity if he lost based on goals he sets against himself.
12. With the GCE smart equipment could pass data to a smart contract that has been established by a golf instructor with specific training goals in it. The instructor could commit to a player that he will teach him to hit a golf ball 25% further and 10% straighter over a period of six one-hour lessons and every swing is measured in detail and recorded immutably. If the instructor cannot achieve the instructional goal the student receives a contract defined rebate.
13. With the GCE game tournaments could be established that cannot exist in the current “real world” environment. Tournaments could be distributed across hundreds of venues around the globe with thousands of players paying at different times over an established calendar period. Every player would be governed by identical rules which are technically and legally adjusted per their physical location and environmental factors. All play would be tracked, reported, validated and recorded by the Smart Contract and submitted to the blockchain for permanent and auditable validation of all transactions, activities, game outcomes and disbursements of consideration.

1: A computerized wagering method including one or more computer-executable instructions for a game creation engine (“GCE”), for creating a game with associated wagers, executing the game, and management of the games, said one or more computer-executable instructions being executed on at least one computing device, said instructions comprising instructions for:
Generating, by said at least one first computing device, at least one smart contract, said smart contract comprising one or more attributes associated with said game and one or more rules associated with said game;
Storing, by said at least one first computing device, said smart contract in a data store; and
Executing, by said at least one first computing device, a game selected by a first user via said at least one computing device, said executing comprising executing one or more smart contracts associated with said game to determine one or more winners of the game.

2: The method of claim 1, said computer-executable instructions including instructions for:
monitoring said executing, said monitoring comprising instructions for storing game information related to attributes of said executing game, said attributes including wager information; and
selectively storing said game information in at least one of a blockchain, an oracle, and an associated data store.

3: The method of claim 1, said computer-executable instructions including instructions for escrowing at least one wager indicated by at least one of said one or more attributes and said one or more rules, wherein said at least one wager would be settled during said executing.

4: The method of claim 1, wherein a second user participates in said game via at least one second computing device, said at least one second computing device being remote with respect to the said at least one first computing device.
